(19) United States
(12) Patent Application Publication
(10) Pub. No.: US 2013/0258411 A1
(43) Pub. Date: Oct. 3, 2013

(54) PRINT INFORMATION OUTPUT APPARATUS, PORTABLE ELECTRONIC DEVICE AND COMPUTER-READABLE MEDIUM

(71) Applicant: CASIO COMPUTER CO., LTD., Tokyo (JP)

(72) Inventor: Taiga Murayama, Tokyo (JP)

(73) Assignee: CASIO COMPUTER CO., LTD., Tokyo (JP)

(21) Appl. No.: 13/852,072

(22) Filed: Mar. 28, 2013

(30) Foreign Application Priority Data
Apr. 2, 2012 (JP) 2012-083722

(51) Int. Cl. G06F 3/12

(52) U.S. Cl. CPC G06F 3/12
USPC 358/1.18

(57) ABSTRACT

The present invention allows various printing related settings with an intuitive operation. In the present invention, a print information output apparatus includes a display control section which controls arbitrary content to be displayed on a display section, a touch gesture determining section which determines the type of a touch gesture performed on a touch panel provided on the display section, an operation execution section which performs an operation based on the type of the touch gesture for the content being displayed on the display section, and an output section which outputs the content being displayed on the display section as print information.

### CROSS-REFERENCE TO RELATED APPLICATION

This application is based upon and claims the benefit of priority from the prior Japanese Patent Application No. 2012-083722, filed Apr. 2, 2012, the entire contents of which is incorporated herein by reference.

### BACKGROUND OF THE INVENTION

1. Field of the Invention

The present invention relates to a print information output apparatus, a portable electronic device, and a computer readable medium. Specifically, the present invention relates to a print information output apparatus, a portable electronic device, and a computer readable medium that are used by being connected to a printing machine (hereinafter, a printer) as required.

2. Description of the Related Art

Today, portable electronic devices such as portable phones are widely available. Among other things, high-functionality portable electronic devices called smartphones can display various information on a screen, such as electronic mails, Internet content, camera images, and documents such as texts, and therefore have established a position as extremely convenient personal portable devices.

On the other hand, in such a portable electronic device, it is desired that not only screen display is made but also various information as described above is printed and retained on a paper medium. To attain this desire, it is general to follow a procedure of transferring information to be printed to a personal computer and then printing the information at a printer connected to the personal computer. This procedure is cumbersome because the personal computer has to be turned on every time printing is performed.

To address this, Japanese Patent Application Laid-Open (Kokai) Publication No. 2003-241911 describes a technology capable of printing necessary information only by connecting a portable electronic device to a printer, that is, a printing technology without requiring a personal computer (this technology is hereinafter referred to as a conventional technology).

However, the conventional technology merely describes print output of necessary information at the printer connected to the portable electronic device, and it is disadvantageously impossible to set a print range or perform operations such as enlargement, reduction, and rotation of print information.

This problem cannot be overlooked particularly in a portable electronic device with a screen of a small display size. The reason for this is that a partially enlarging operation or the like is often performed when, for example, Internet content such as a homepage designed for personal computers are viewed on the small screen of the portable electronic device. Also, when saving the display information as printed matter, often a printout of only the manipulated portion is desired in order to reduce paper waste or shorten printing time.

### SUMMARY OF THE INVENTION

The present invention has been conceived in light of the above-described problems. An object of the present invention is to provide a print information output apparatus, a print information output method, program, and a portable electronic device capable of making various printing related settings with an intuitive operation.

In accordance with one aspect of the present invention, there is provided a print information output apparatus comprising: a display control section which controls arbitrary content to be displayed on a display section; an operation execution section which performs an operation based on type of a touch gesture performed on a touch panel provided on the display section in relation to the content; a judging section which judges whether the content after the operation based on the type of the touch gesture has been enlarged beyond a predetermined area; a page setup changing section which changes page setup for printing when the judging section judges that the content has been enlarged beyond the predetermined area; and an output section which outputs the content and the page setup as print information.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A to FIG. 1C are external views of a portable phone 1;

FIG. 2 is a structural diagram of the portable phone 1;

FIG. 3 is a diagram of a connection state between the portable phone 1 and a printer 20;

FIG. 4 is a conceptual diagram of functions of the portable phone 1;

FIG. 5 is a diagram of an operation flow of the portable phone 1;

FIG. 6 is a diagram of a sub-routine flow of content operation processing (Step S200);

FIG. 7A to FIG. 7D are diagrams of an operation flow of a portable phone of a second embodiment;

FIG. 8A to FIG. 8C are diagrams of an operation flow of the portable phone of the second embodiment;

FIG. 9 is a diagram of an operation flow of the portable phone in the second embodiment; and

FIG. 10 is a diagram of a sub-routine flow of processing of content operation 2 (Step S4000) of the second embodiment.

### DETAILED DESCRIPTION OF THE PREFERRED EMBODIMENTS

### First Embodiment

A first embodiment of the present invention is described with reference to the drawings with application to a smartphone-type portable phone being taken as an example.

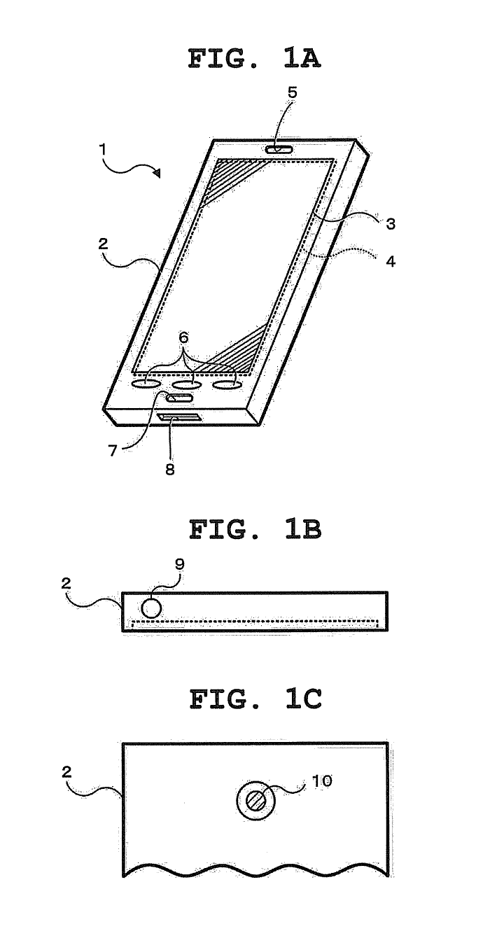

FIG. 1A to FIG. 1C are external views of a portable phone 1. In this drawing, the portable phone 1 has a housing 2 in a shape allowing hand-held use (for example, a tablet-type housing 2). The housing 2 has a main surface serving as an operation surface, where a display section 4 having a touch panel 3 mounted thereon, a receiver hole 5, a plurality of (here, three) hard keys 6, and a speaker hole 7 are provided. On a bottom surface on a lower end side of the main surface, a dual-purpose connector 8 is provided for connecting an external I/F (interface) 17, which will be described further below, and charging a power supply section 18, which will be described further below. A power button 9 is provided on a top surface of the housing 2 on an upper end side of the main surface, and a taking lens 10 of an imaging section 14, which will be described further below, is provided on a surface (a rear surface) opposite to the main surface.

While the so-called smartphone type portable phone 1 having the tablet-type housing 2 is described herein, this is not meant to be restrictive. The portable phone 1 may have a housing of a folding type, a sliding type, or other types.

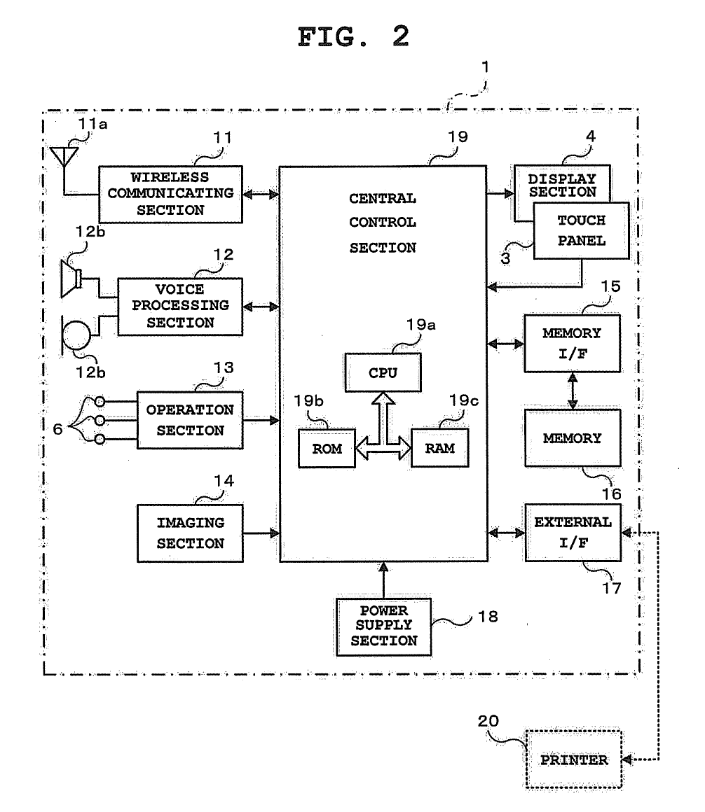

FIG. 2 is a structural diagram of the portable phone 1. The portable phone 1 includes, for example, a wireless communicating section 11, a voice processing section 12, an operation section 13, the imaging section 14, the display section 4 including the touch panel 3, a memory I/F (interface) 15, a memory 16, the external I/F 17, the power supply section 18, and a central control section 19.

The wireless communicating section 11 is a wireless communicating section for portable telephone, wirelessly transmitting and receiving digital data with the nearest base station (omitted in the drawing) via an antennal 11a. The digital data includes data regarding incoming and outgoing telephone calls exchanged via a portable telephone network or a general public telephone network, data regarding voice call, and, as required, data to be exchanged with a resource (for example, a server) on a network (such as the Internet not shown in the drawing). The wireless communicating section 11 transmits and receives the digital data described above under the control of the central control section 19.

While the wireless communicating section 11 is described as the one “for portable telephone”, this is not meant to be restrictive. For example, the wireless communicating section 11 may be for a wireless LAN. In this case, while establishing a connection with a nearby wireless LAN relay apparatus (an access point) via the antenna 11a to wirelessly transmit and receive digital data, the wireless communicating section 11 accesses a resource on the network connected to the access point.

Under the control of the central control section 19, the voice processing section 12 converts a voice signal picked up with a microphone 12a to digital data for output to the central control section 19, and converts a digital voice signal outputted from the central control section 19 to an analog signal for amplification from a loudspeaker 12b. The microphone 12a and the loudspeaker 12b are for incoming and outgoing telephone calls. The loudspeaker 12b is also used for beating for notifying incoming calls.

The operation section 13 detects a user operation on the plurality of hard keys 6 depicted in FIG. 1A, and generates a key signal corresponding to the operated key for output to the central control section 19.

The imaging section 14 includes the taking lens 10 depicted in FIG. 1C and a two-dimensional imaging device such as a CCD (Charge Coupled Device) image sensor or a CMOS (Complementary Metal Oxide Semiconductor) image sensor. Under the control of the central control section 19, the imaging section 14 takes a still picture or a moving picture of any subject, and outputs image data of the taken picture to the central control section 19.

The display section 4 is a flat display device such as a liquid-crystal display, an organic liquid-display panel, or an EL (Electro-Luminescence) panel, and has a front surface provided with the touch panel 3. In the present embodiment, a multi-touch-type (capacitive) touch panel capable of detecting a contact with part of the human body (typically, a fingertip), an electrostatic pen, or the like at a plurality of points is used as the touch panel 3.

In general, touch operations on a multi-touch-type touch panel include a tap (an operation of lightly tapping with a finger, corresponding to a click of a mouse), a double tap (an operation of tapping twice, corresponding to a double click), a drag (an operation of shifting a finger to be preformed when an object such as a photograph is moved), a flick (an operating of lightly flicking with a finger when objects in a list or the like are scrolled), a pinch (a generic name for an operation of pinching with a plurality of fingers), a pinch-out (an operation for enlargement by widening a space between fingers, also called a pinch open), and a pinch-in (an operation for reduction by narrowing a space between fingers, also called a pinch close). These touch operations are each called a “touch gesture”.

The memory I/F 15 is, for example, a general-purpose interface supporting the standards of the memory 16 (such as an SD card), and is positioned between the central control section 19 and the memory 16 for interfacing data exchanges therebetween.

The memory 16 is a non-volatile and rewritable information storage element. For example, a flash memory such as an SD card, a silicon disk, or a hard disk can be used. The memory 16 has various user data stored and retained therein (such as an electronic telephone book, image data acquired by the imaging section 14, and content data such as images and music downloaded from the Internet).

The external I/F 17 is a data interface with external devices such as a personal computer. One key point of the present embodiment is that one of the external devices is a printer 20. For example, when the external device connected to the external I/F 17 is a personal computer, the personal computer can access the memory 16 via the external I/F 17 and the central control section 19. As required, the external I/F 17 retrieves user data stored in the memory 16 or writes the user data back from the external device to the memory 16. When the printer 20 is connected to the external I/F 17, the printer 20 can print information sent as appropriate from the central control section 19 via the external I/F 17 onto paper for output.

The power supply section 18 includes a battery formed of a primary battery or a chargeable secondary battery. From power from the battery, the power supply section 18 generates various power supply voltages required for the operation of the portable phone 1 and supplies the generated voltages to the respective sections.

The central control section 19 is a program-controlled-type control element including a computer or microcomputer (hereinafter, a CPU (Central Processing Unit) 19a), a read-only semiconductor memory (hereinafter, a ROM (Read Only Memory) 19b), a high-speed semiconductor memory (hereinafter, a RAM (Random Access Memory) 19c), and a peripheral circuit not shown. With a control program stored in advance in the ROM 19b being loaded to the RAM 19c and executed at the CPU 19a, the central control section 19 sequentially performs various processing and controls an entire operation of the portable phone 1 in a centralized manner. The ROM 19b may be a rewritable and nonvolatile semiconductor memory (such as a flash memory or PROM (Programmable Read Only Memory)).

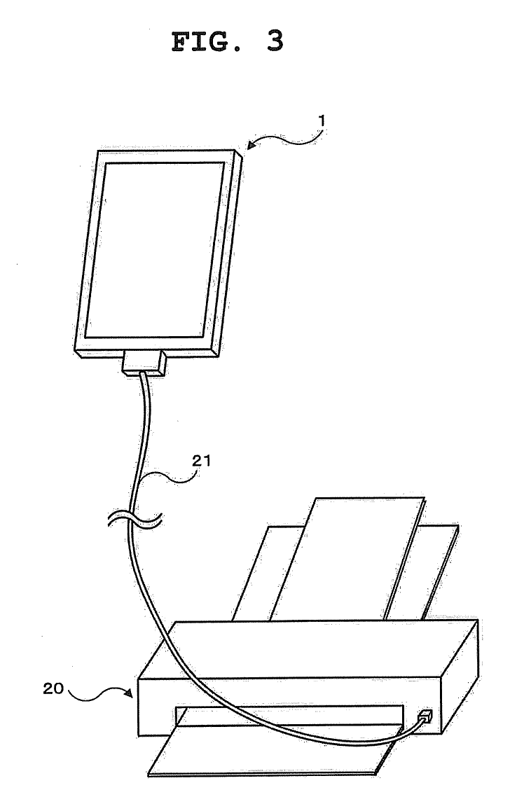

FIG. 3 is a diagram of a connection state between the portable phone 1 and the printer 20. As depicted in the drawing, the portable phone 1 and the printer 20 can be connected via a cable 21 as required. The connection between the portable phone 1 and the printer 20 is not restricted to the cable connection depicted in the drawing. For example, the connection may be a wireless connection using a short-distance communication technology such as Wireless Fidelity (Wi-Fi) or Bluetooth (registered trademark).

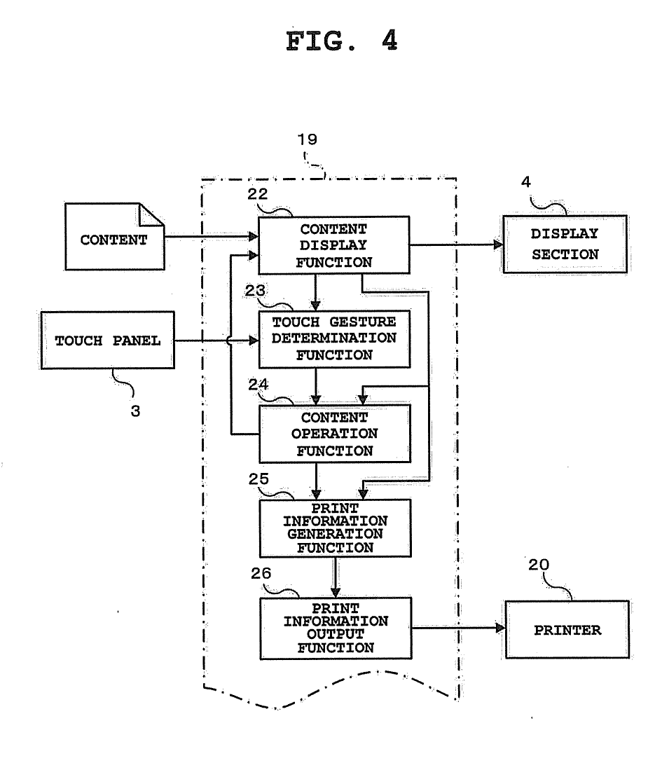

FIG. 4 is a conceptual diagram of functions of the portable phone 1. The “functions” refer to operations, motions, or mechanisms virtually achieved by organically connecting a hardware resource such as the CPU 19a and a software resource such as a control program in the central control section 19. The functions lack material substance (form).

The functions achieved in the central control section 19 of the present embodiment include, for example, a content display function 22 for displaying any content selected by a user on the display section 4, a touch gesture determination function 23 for determining the type of a touch operation on the touch panel 3 (a touch gesture), a content operation function 24 for performing a predetermined operation (such as reduction, enlargement, rotation, or movement) on the content being displayed on the display section 4 based on the determination result of the touch gesture determination function 23, a print information generation function 25 for generating print information (content within a range of being displayed on the display section 4), and a print information output function 26 for outputting the print information to an external printing machine (refer to the printer 20 of FIG. 3).

While these functions lack material substance (form) as described above, the present invention is not restricted to this mode (of lacking material substance). In the idea of the present invention, an entire or part of each function described above may be configured of “material substance”, that is, for example, a hard logic.

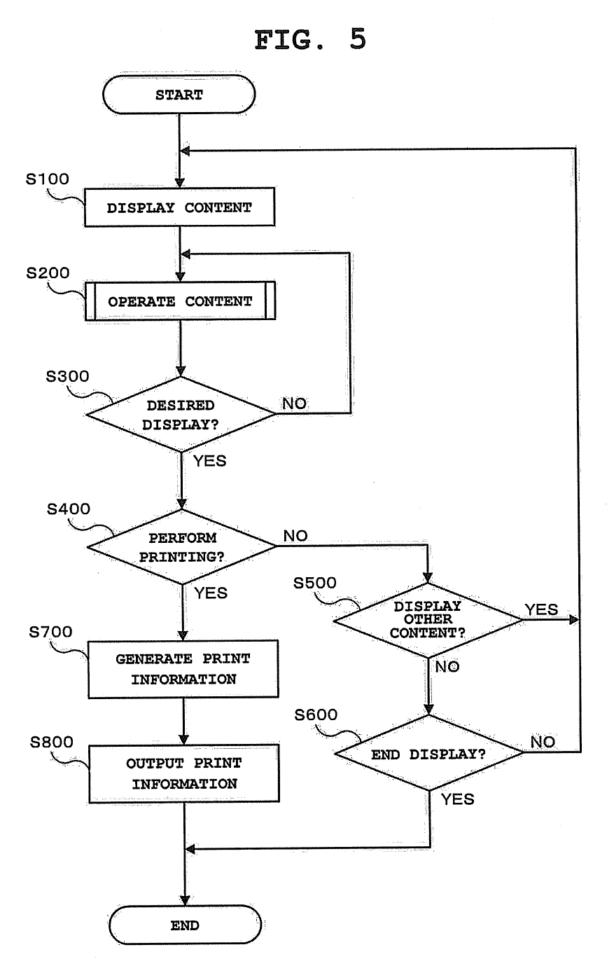

FIG. 5 is a diagram of an operation flow of the portable phone 1. This operation flow corresponds to a flow of main parts of a control program to be executed by the CPU 19a of the portable phone 1. Therefore, the subject executing each step described below is the CPU 19a.

In this operation flow, the CPU 19a first selects content, and displays the content on the display section 4 (Step S100). The content includes transmission and reception data of electronic mails, Internet content such as homepages, camera images taken by the imaging section 14, or documents such as texts captured from an external device such as a personal computer.

When the content is displayed, the CPU 19a performs content operation processing (Step S200).

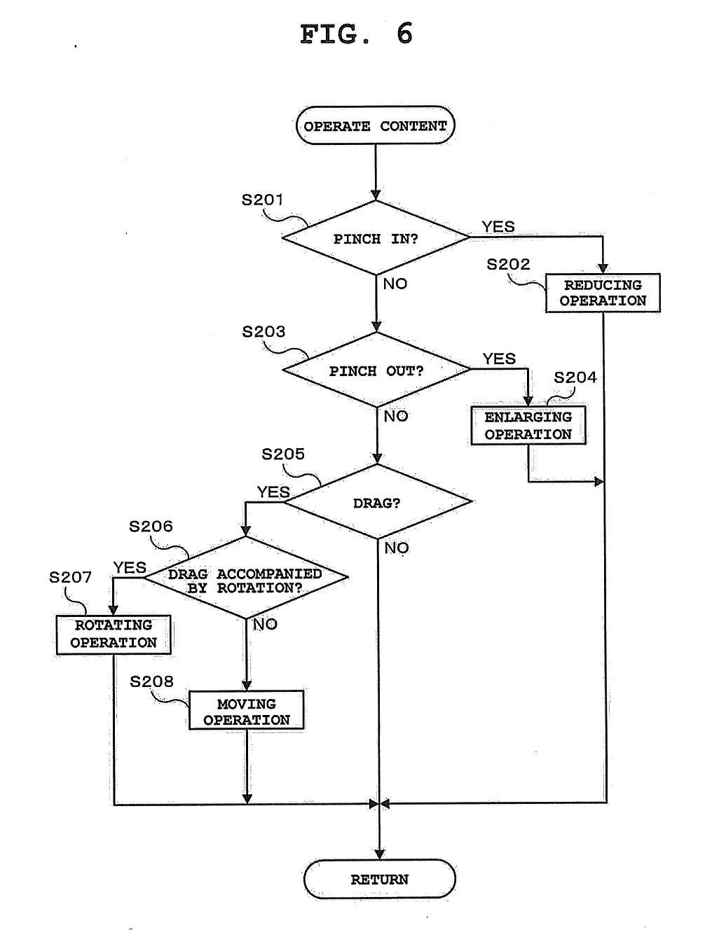

FIG. 6 is a diagram of a sub-routine flow of the content operation processing (Step S200). In this flow, the type of a touch gesture on the touch panel 3 is determined (Step S201, Step S203, Step S205, and Step S206), a content operation corresponding to the determination result (the type of the touch gesture) is performed (Step S202, Step S204, Step S207, and Step S208).

Here, it is assumed that the touch gesture has four types: “pinch-in”, “pinch-out”, “drag with rotation”, and “drag without rotation”. A pinch-in refers to a touch gesture of narrowing a space between two fingers touching on the touch panel. A pinch-out refers to a touch gesture of widening the space therebetween. A drag refers to a touch gesture of sliding the fingers touching on the touch panel. While the touch gesture is assumed to have four types herein, it goes without saying that this is not meant to be restrictive. Another touch gesture may be added (such as a tap of immediately moving fingers off the touch panel and a long tap of continuously touching with fingers). Alternatively, the four types of touch gestures may be replaced by these other touch gestures.

In the example depicted in the drawing, each combination of a touch gesture and a content operation is as follows.

(1) When a pinch-in is determined (YES at Step S201), the CPU 19a performs a content reducing operation (Step S202). The degree of reduction depends on the amount of pinching.

(2) When a pinch-out is determined (YES at Step S203), the CPU 19a performs a content enlarging operation (Step S204). The degree of enlargement depends on the amount of pinching.

(3) When a drag is determined (YES at Step S205) and the drag is with rotation (YES at Step S206), the CPU 19a performs a content rotating operation (Step S207). When the drag is without rotation (NO at Step S206), the CPU 19a performs a content moving operation (Step S208). The direction and magnitude of rotation depend on the rotating direction and amount of dragging. Also, the direction and magnitude of movement depend on the direction and amount of dragging.

The example described above is obtained by appropriately combining the user's intention of operating regarding the content and an intuitive touch gesture for achieving the intention. That is, the user who desires to reduce the content is supposed to perform a pinch-in naturally. Conversely, the user who desires to enlarge the content is supposed to perform a pinch-out naturally. The user who desires to rotate the content is supposed to perform a drag with rotation naturally, and the user who desires to move the content is supposed to perform a drag in a predetermined direction without rotation naturally.

Referring back to FIG. 5, after the content operation is performed as described above, the user determines whether the display on the display section 4 is a desired display, that is, a reduced display, an enlarged display, a rotated display, or a moved display as desired. If the display is not as desired, the CPU 19a performs the content operation processing (Step S200) again. If the display is as desired, the CPU 19a judges whether a print execution button (for example, any one of the hard keys 6 of FIG. 1A) has been pressed (Step S400).

If the print execution button has not been pressed, the CPU 19a judges whether other content is to be displayed (Step S500). If other content is to be displayed, the CPU 19a returns to Step S100 again. If other content is not to be displayed, the CPU 19a judges whether a display end button (for example, any one of the other hard keys 6 of FIG. 1A) has been pressed (Step S600). If the display end button has been pressed, the flow ends. If the display end button has not been pressed, the CPU 19a returns to Step S100 again.

If the judgment result at Step S400 is YES, that is, if the print execution button has been pressed, the CPU 19a generates the content being displayed on the display section 4 as print information (Step S700), and promotes a connection between the portable phone 1 and the printer 20. After the connection is confirmed, the CPU 19a outputs the print information to the printer 20 (Step S800), and performs printing by the printer 20.

While the content being displayed is generated as print information in the present embodiment, this is not meant to be restrictive. The selected content and the content being displayed may be compared with each other, and a scaling factor for enlargement or reduction, a left or right rotation angle, and the like may be calculated for print settings, and the selected content and the print settings may be taken as print information.

As described above, according to the present embodiment, while content being displayed on the display section 4 is being viewed, various operations such as reduction, enlargement, rotation, and movement of the content can be intuitively performed with touch gestures on the touch panel 3. Furthermore, as required, the content being displayed on the display section 4 (the content after various operations such as reduction, enlargement, rotation, and movement are performed) can be directly outputted to the printer 20 for printing.

Therefore, it is possible to provide a print information output apparatus, print information output method, program, and portable electronic device capable of performing printing without requiring a personal computer and also making various printing related settings with an intuitive operation.

While execution of printing is assigned to one of the hard keys 6 of FIG. 1A in the present embodiment, this is not meant to be restrictive. For example, execution of printing may be assigned to a specific touch event on the touch panel 3 (for example, a long touch event also called “press and hold”).

Also, while application to a portable phone is taken as an example in the present embodiment, this is not meant to be restrictive. Application may be made to any portable electronic device including a display section with a multi-touch-type touch panel. For example, the portable electronic device may be a PDA (Personal Digital Assistant), a game machine, an electronic dictionary, a digital still camera, a digital video camera, or a car navigation device.

### Second Embodiment

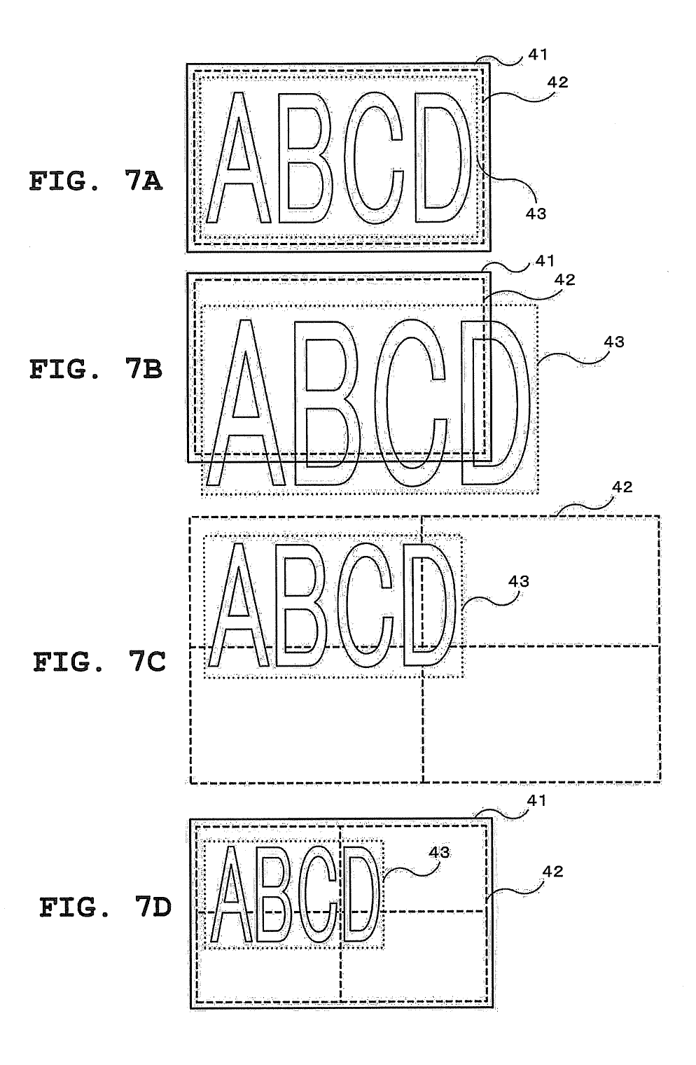

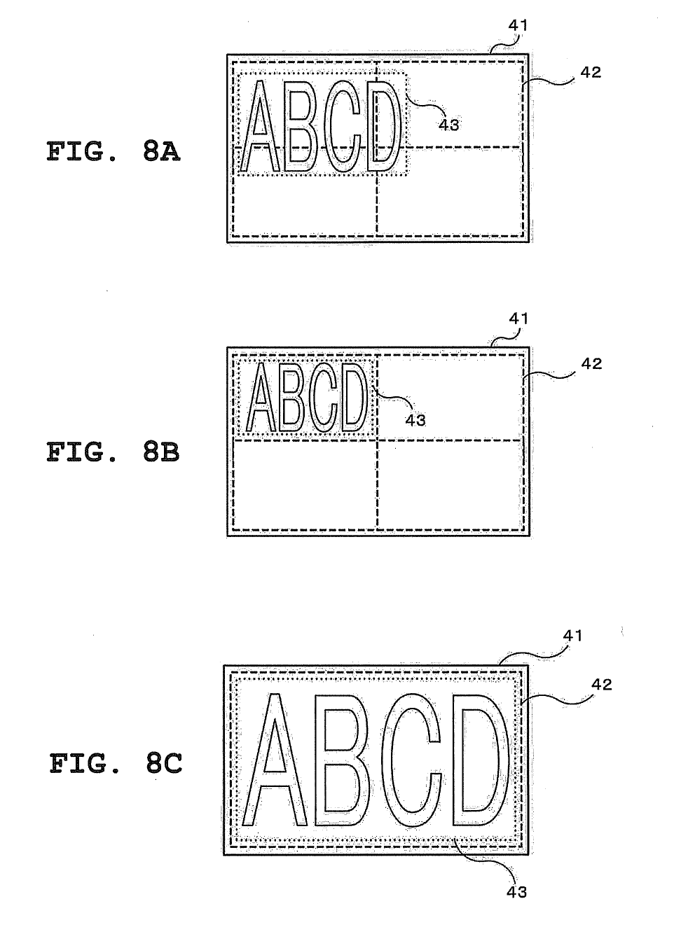

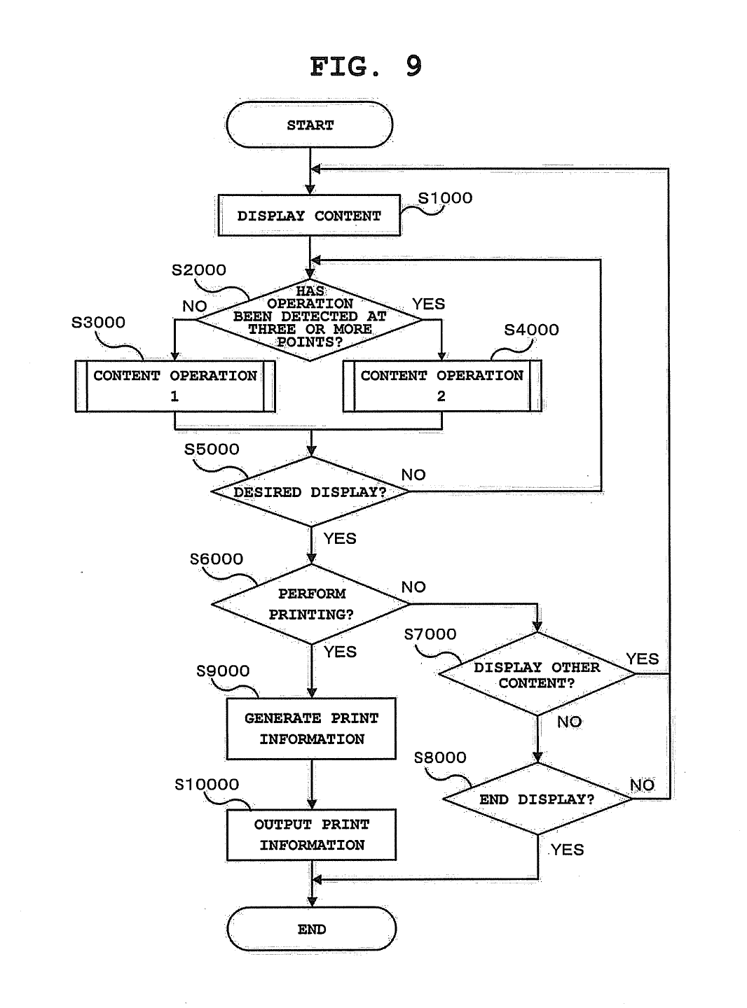

Next, a second embodiment of the present invention is described by using FIG. 7A to FIG. 7D, FIG. 8A to FIG. 8C, and FIG. 9.

In the second embodiment, a plurality of touch operations regarding operations of enlargement, reduction, rotation, and movement are used. In one operation, the same processing as that of the first embodiment is performed. In another operation where, for example, three fingers are used for operation, settings for printing with a plurality of pages are outputted when an image area 43 of content is enlarged beyond a page area 42 displayed on the display section 4.

The structure of the portable phone 1 of the present embodiment is identical to that of the first embodiment, and is therefore not described herein.

First, the operation of the second embodiment is described by using FIG. 7A to FIG. 7D.

FIG. 7A is a diagram when content is displayed. A display area 41 surrounded by a solid line represents the area of the display section 4 of the portable phone 1. The page area 42 surrounded by a broken line represents the printing area of a paper sheet of a predetermined size that is used for printing by the printer 20. The image area 43 surrounded by a dotted line represents the area of content.

A diagram when an enlarging operation is performed with three fingers from the state in FIG. 7A is depicted in FIG. 7B.

The image area 43 within the page area 42 has been increased by the enlarging operation to enlarge beyond the page area 42. Here, what is displayed on the display section 4 of the portable terminal is the display area 41 surrounded by the solid line.

When an operation is performed with user's three fingers to cause the image area 43 to enlarge beyond the page area 42, page setup change processing is performed. In the page setup change processing, it is first detected in which direction, that is, an upward, downward, leftward, or right ward direction, the image area 43 lies off the page area 42. In FIG. 7B, the image area 43 lies off the page area 42 in a rightward direction and a downward direction.

In this case, the page area 42 is widened in the rightward direction and the downward direction. Here, the page area is widened by an integral multiple of the initial page area. With this, the printer 20 can smoothly perform printing without changing the paper sheet size even at the time of printing a plurality of pages.

After the page area 42 is widened in the rightward direction and the downward direction, the page area 42 is widened so as to be in a rectangular shape. This processing is repeated until the image area 43 is within the page area 42. Then, the number of pages is calculated, and a layout of areas on each page is determined.

FIG. 7C is a diagram showing a state after the page setup change processing is performed. Since the page setup change processing has been performed, the image area 43 is within the page area 42 and print settings have been made by which the content is printed by being divided into four pages.

Thereafter, the page area 42 is reduced so as to be within the display area 41, and is displayed on the display section 4.

FIG. 7D is a diagram of a display example of the display section 4 after the page setup change processing is performed.

The page setup change processing is also performed when, for example, a reducing operation is performed with three fingers and a totally-blank page is present.

FIG. 8A is a diagram when an enlarging operation is performed with three fingers, the image area 43 is enlarged beyond the page area 42, page setup change processing is performed, and settings are made by which the content is printed by being divided into four pages.

FIG. 8B is a diagram when a reducing operation is performed thereafter with user's three fingers, and areas other than a area on an upper left page of the page area 42 where the image area 43 is present are blank.

Here, each page of the page area 42 and the image area 43 are compared with each other, and it is judged whether any totally-blank page is present. Any totally-blank page found is deleted. Then, a page layout is determined so that the remaining page area 42 is in a rectangular shape, and the page layout is displayed.

FIG. 8C is a diagram after a reducing operation is performed with three fingers and page setup change processing is performed.

FIG. 9 is a diagram showing an operation flow of the portable phone 1 in the second embodiment. The operation flow corresponds to a flow of main parts of the control program to be executed at the CPU 19a of the portable phone 1. Therefore, the subject executing each step described below is the CPU 19a.

In this operation flow, the CPU 19a first selects content, and displays the content on the display section (Step S1000). Since Step S1000 is identical to Step S100 of FIG. 5 in the first embodiment, detailed description is omitted.

Next, the CPU 19a judges whether a user touch operation has been detected by the touch panel 3 at three or more points (Step S2000). If the number of the points is smaller than three, a content operation 1 at Step S3000 is performed. Since the content operation 1 at Step S3000 is identical to S200 of FIG. 5 and the flow of FIG. 6, description is omitted.

If the operation has been detected at three or more points at Step S2000, a content operation 2 at Step S4000 is performed.

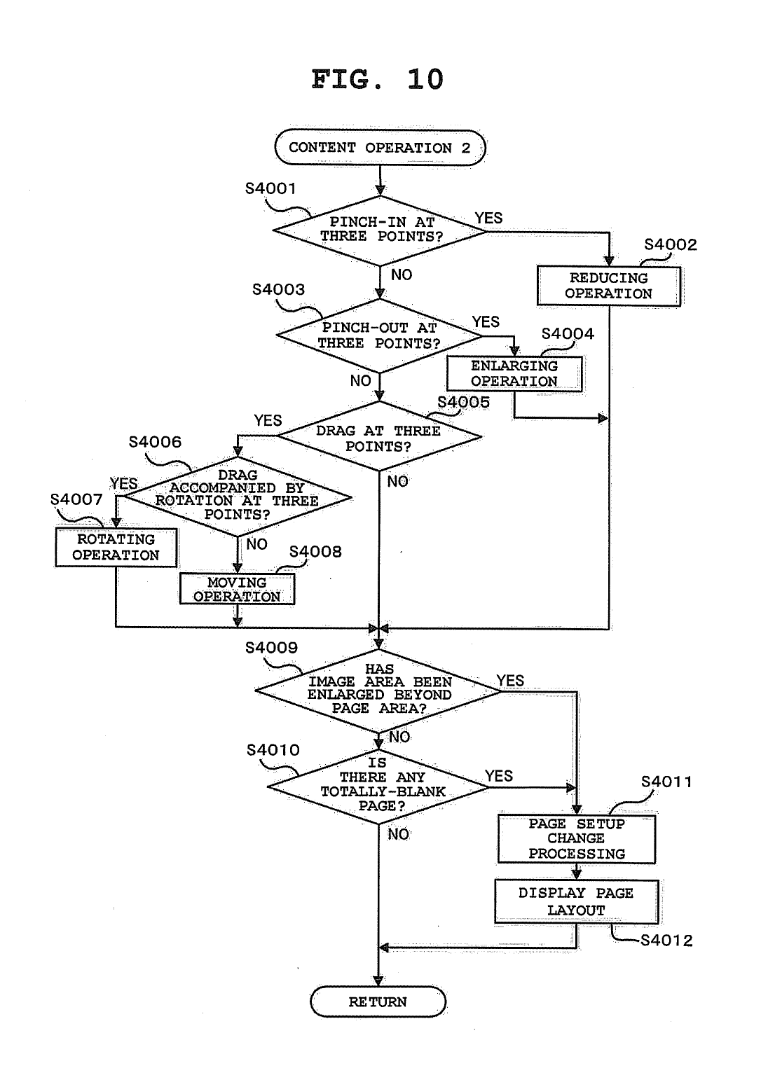

FIG. 10 is a diagram showing a sub-routine flow of processing of the content operation 2 (Step S4000). In this flow, the type of a touch gesture on the touch panel 3 is determined (Step S4001, Step S4003, Step S4005, and Step S4006), and a content operation corresponding to the determination result (the type of the touch gesture) is performed (Step S4002, Step S4004, Step S4007, and Step S4008).

Here, unlike the first embodiment, it is assumed that the touch gesture has four types: “pinch-in at three points”, “pinch-out at three points”, “drag with rotation at three points”, and “drag without rotation at three points”. A pinch-in at three points refers to a touch gesture of narrowing a space among three fingers touching on the touch panel. A pinch-out at three points refers to a touch gesture of widening the space thereamong. A drag refers to a touch gesture of sliding the three fingers touching on the touch panel. Note that, although the touch gesture is assumed to have four types herein, the present invention is not limited thereto and another touch gesture may be added (such as a tap of immediately moving fingers off the touch panel and a long tap of continuously touching with fingers). Alternatively, the four types of touch gestures may be replaced by these other touch gestures.

While the number of fingers to be detected by the touch panel 3 in the touch gesture of the second embodiment is different, each combination of a touch gesture and a content operation is identical to that of the first embodiment, and is therefore not described herein.

After the steps described above are performed, the CPU 19a judges whether the image area 43 has been enlarged beyond the page area 42 (Step S4009). If the image area 43 has been enlarged beyond the page area 42, the process proceeds to Step S4011. If the image area 43 has not been enlarged beyond the page area 42, the process proceeds to Step S4010.

At Step S4010, the CPU 19a judges whether any blank page is present in the page area 42. If any blank page is present, the process proceeds to Step S4011. If no blank page is present, the process returns to Step S5000 of FIG. 9.

At Step S4011, the CPU 19a performs page setup change processing as described in FIG. 7A to FIG. 7D and FIG. 8A to FIG. 8C, and displays the resultant page layout on the display section 4 (Step S4012).

Then, the process returns to Step S5000 of FIG. 9.

Steps S5000 to S10000 in FIG. 9 are identical to Steps S300 to S800 in FIG. 5 in the first embodiment, and are therefore not described herein.

While the second embodiment includes the page area 42 and the display area 41, this is not meant to be restrictive. The page area 42 may be set identical to the display area and the page layout may be displayed.

While each operation is made with three fingers when the page setup is changed in the second embodiment, this is not meant to be restrictive. Each operation may be any as long as it is detected with a different method.

While it is judged, after an enlarging operation is performed with three fingers, in which direction, that is, an upward, downward, leftward, or rightward direction, the image area lies off the page area and then the page setup is changed in the second embodiment, this is not meant to be restrictive. The area of the image area 43 and the area of the page area 42 on one page may be compared with each other to determine the page layout.

While it is judged, after a reducing operation is performed with three fingers, whether any totally-blank page is present in the second embodiment, this is not meant to be restrictive. For example, the area of the image area 43 being displayed and the area of the page area 42 on one page may be compared with each other to determine the page layout.

While the number of pages is changed in the page setup change processing in the second embodiment, this is not meant to be restrictive. The paper sheet size may be changed. Here, the paper sheet size is displayed on the display section 4.

While the present invention has been described with reference to the preferred embodiments, it is intended that the invention be not limited by any of the details of the description therein but includes all the embodiments which fall within the scope of the appended claims.

What is claimed is:

1. A print information output apparatus comprising:
a display control section which controls arbitrary content to be displayed on a display section;
an operation execution section which performs an operation based on type of a touch gesture performed on a touch panel provided on the display section in relation to the content;
a judging section which judges whether the content after the operation based on the type of the touch gesture has been enlarged beyond a predetermined area;
a page setup changing section which changes page setup for printing when the judging section judges that the content has been enlarged beyond the predetermined area; and
an output section which outputs the content and the page setup as print information.

2. The print information output apparatus according to claim 1, further comprising:
a display section which displays the page setup changed by the page setup changing section.

3. The print information output apparatus according to claim 2, wherein the page setup comprises a page layout.

4. The page information output apparatus according to claim 2, wherein the page setup comprises a paper sheet size.

5. The page information output apparatus according to claim 1, wherein the touch gesture is a first touch gesture accompanied by a page setup change or a second touch gesture not accompanied by a page setup change, and
wherein the judging section judges whether the content after an operation based on type of the second touch gesture has been enlarged beyond the predetermined area.

6. The page information output apparatus according to claim 2, wherein the touch gesture is a first touch gesture accompanied by a page setup change or a second touch gesture not accompanied by a page setup change, and
wherein the judging section judges whether the content after an operation based on type of the second touch gesture has been enlarged beyond the predetermined area.

7. The page information output apparatus according to claim 3, wherein the touch gesture is a first touch gesture accompanied by a page setup change or a second touch gesture not accompanied by a page setup change, and
wherein the judging section judges whether the content after an operation based on type of the second touch gesture has been enlarged beyond the predetermined area.

8. The page information output apparatus according to claim 4, wherein the touch gesture is a first touch gesture accompanied by a page setup change or a second touch gesture not accompanied by a page setup change, and
wherein the judging section judges whether the content after an operation based on type of the second touch gesture has been enlarged beyond the predetermined area.

9. The print information output apparatus according to claim 1, wherein the page setup changing section detects whether the content lies off the predetermined area in an upward, downward, leftward, or rightward direction, and changes the page setup based on a detection result.

10. The print information output apparatus according to claim 1, wherein the page setup changing section compares an area where the content is displayed and area of the predetermined area with each other and changes the page setup based on a comparison result.

11. The print information output apparatus according to claim 1, wherein the touch gesture is a pinch-in or a pinch-out, or a drag accompanied by rotation or a drag not accompanied by rotation.

12. The print information output apparatus according to claim 1, wherein the output section outputs content being displayed on the display section when the touch panel is judged to have been pressed and held, as print information.

13. A non-transitory computer-readable storage medium having stored thereon a program that is executable by a computer, the program being executable by the computer to perform functions comprising:
display control processing for controlling arbitrary content to be displayed on a display section;
operation execution processing for performing an operation based on type of a touch gesture performed on a touch panel provided on the display section in relation to the content;
judgment processing for judging whether the content after the operation based on the type of the touch gesture has been enlarged beyond a predetermined area;
page setup change processing for changing page setup for printing when the judgment processing judges that the content has been enlarged beyond the predetermined area;
display processing for displaying the page setup changed by the page setup change processing; and
output processing for outputting the content and the page setup as print information.
